(19) United States
(12) Patent Application Publication
(10) Pub. No.: US 2025/0283538 A1
(43) Pub. Date: Sep. 11, 2025

(54) SINGLE GATE VALVE

(71) Applicant: Kinetic Pressure Control Ltd., Houston, TX (US)

(72) Inventors: Steven A. Angstmann, Houston, TX (US); Billy J. Gallagher, Houston, TX (US)

(73) Assignee: Kinetic Pressure Control Ltd., Houston, TX (US)

(21) Appl. No.: 18/858,320

(22) PCT Filed: Apr. 15, 2023
(86) PCT No.: PCT/US2023/018749

§ 371 Date: Oct. 20, 2024

Related U.S. Application Data
(60) Provisional application No. 63/335,642, filed on Apr. 27, 2022.
(60) Provisional application No. 63/458,641, filed on Apr. 11, 2023.

(51) Int. Cl. F16K 3/314; F16K 3/02; F16K 27/04

(52) U.S. Cl. CPC F16K 3/314; F16K 3/0227; F16K 3/0272; F16K 27/044

(57) ABSTRACT

A valve has a body having a through bore. A gate is disposed in a passage transverse to the through bore, with the gate configured for motion between a position with an opening on the gate coincident with the through bore to permit fluid flow via the through bore and a position to restrict fluid flow via the through bore. The gate is configured for motion along the transverse passage in one direction in response to a first force acting on the gate and in another direction in response to a second force acting on the gate. A method of operating a valve.

### BACKGROUND

This disclosure relates to the field of mechanical valves. More specifically, the disclosure relates to gate valve designs for selective fluid communication in general applications.

Valves to control the transmission and flow of fluids have been in use for centuries. Gate valves are well known and applied in various industries. In oilfield operations (e.g., fracking applications), gate valves are commonly used to handle fluid flow at each well. Such valves are exposed to extremely harsh fluids (e.g., sand slurries) that significantly reduce the operational life of the gates. Conventional gate valves are designed with a stem and stem packing configuration, which is less than ideal for such applications. A typical gate valve applied in a fracking operation will require refurbishment approximately every two weeks during operation. This type of maintenance is time consuming and costly, often requiring shipment of the valve to a workshop for repair. Thus, a need remains for improved valve designs to handle various types of fluid transmission.

### SUMMARY

One aspect of the present disclosure is a valve including a main body having a through bore, a passage transverse to the through bore, and a gate disposed in the transverse passage. The gate is configured for motion between a position with an opening on the gate coincident with the through bore to permit fluid flow via the through bore and a position to restrict fluid flow via the through bore. The gate is configured for motion along the transverse passage in one direction in response to a first force acting on the gate and in another direction in response to a second force acting on the gate.

Another aspect of the present disclosure is a method of operating a valve having a main body with a through bore. The method includes applying a force on a gate to move the gate along a passage in the main body transverse to the through bore, wherein the gate is configured for motion along the transverse passage between a position with an opening on the gate coincident with the through bore to permit fluid flow via the through bore and a position to restrict fluid flow via the through bore. The gate is configured for motion along the transverse passage in one direction in response to a first force acting on the gate and in another direction in response to a second force acting on the gate.

### DESCRIPTION OF THE DRAWINGS

FIG. 1 shows an oblique view of a valve embodiment according to this disclosure.

FIG. 2 shows a view of a gate cartridge in a valve embodiment according to this disclosure.

FIG. 3A shows a schematic of a valve embodiment in an open position according to this disclosure.

FIG. 3B shows the valve of FIG. 3A in a closed position according to this disclosure.

FIG. 4 shows an oblique transparency of valve embodiment according to this disclosure.

FIG. 5 shows a cross section view of a valve embodiment according to this disclosure.

FIG. 6 shows an overhead cutaway view of a valve embodiment according to this disclosure.

FIG. 7 shows a schematic of a valve spool embodiment according to this disclosure.

FIG. 8 shows a schematic of a valve embodiment with a removable end cap according to this disclosure.

FIG. 9 shows a valve embodiment disposed in a fluid system according to this disclosure.

FIG. 10 shows a schematic of another valve embodiment according to this disclosure.

FIG. 11 shows a cross section view of a valve embodiment according to this disclosure.

FIG. 12 shows the valve of FIG. 11 in a closed position according to this disclosure.

FIG. 13 shows a fluid/gas flow schematic of a valve embodiment according to this disclosure.

FIG. 14 shows a cross section view of another valve embodiment according to this disclosure.

FIG. 15 shows an overhead view of the valve of FIG. 14 according to this disclosure.

FIG. 16 shows another overhead view of the valve of FIG. 14 according to this disclosure.

### DETAILED DESCRIPTION

Illustrative embodiments are disclosed herein. In the interest of clarity, not all features of an actual implementation may be described. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The disclosed embodiments are not to be limited to the precise arrangements and configurations shown in the figures, in which like reference numerals may identify like elements. Also, the figures are not necessarily drawn to scale, and certain features may be shown exaggerated in scale or in generalized or schematic form, in the interest of clarity and conciseness.

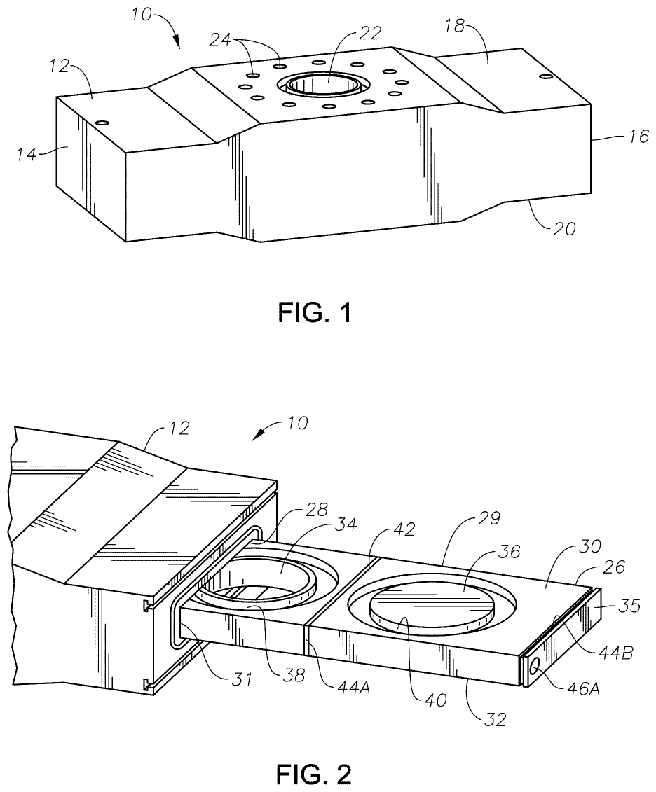

FIG. 1 shows a valve 10 embodiment according to this disclosure. The valve 10 has a main body 12, a first end 14, a second end 16, a first surface 18, and a second surface 20 opposite the first surface. A through bore 22 traverses through the body 12, providing an open passage between the first surface 18 and the second surface 20. Although the embodiment of FIG. 1 shows the through bore 22 configured as a cylindrical opening, the bore may be configured in other geometrical shapes as desired for the application (e.g., oval, octagonal, etc.). The body 12 may be formed of any suitable material depending on the application (e.g., metal, composites, plastics, synthetic materials, etc.). Although FIG. 1 shows an embodiment configured with a generally planar body 12 design, embodiments may be implemented with bodies comprising other geometrical designs more suitable for the desired application.

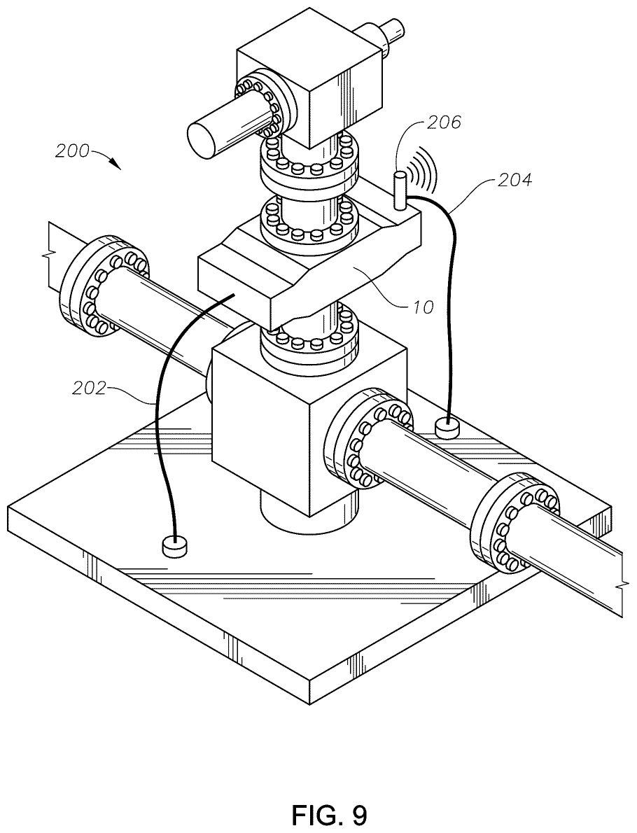

Some valve 10 embodiments may be configured with threaded holes 24 formed on each surface 18, 20 to receive mounting bolts for mounting of the valve 10 onto a fluid transmission system as known in the art (see FIG. 9). Embodiments may also be configured with the holes 24 passing through the entire body 12 for engagement of the valve 10 to flange units using extended length bolts. It will be appreciated by those skilled in the art that other embodiments may be configured for disposal of the valve 10 onto fluid lines or systems in various fashions depending on the application (e.g., welded onto a line, affixed with clamps, etc.).

FIG. 2 shows a view of a valve 10 embodiment according to this disclosure. The valve 10 is shown with a gate 26 extending out of a slot 28 formed within the body 12. In this embodiment, the gate 26 is configured as a rectangular-shaped planar body 29 with a first face 30 and a second face 32. The gate 26 has an opening 34 formed near a first end 31. The opening 34 is preferably shaped to coincide with the geometric shape of the through bore 22 formed in the valve 10 body. The gate 26 provides a solid surface area 36 near a second end 35. FIG. 2 shows the opening 34 surrounded by a seal trench 38. The other end with the solid surface area 36 also has a seal trench 40 formed thereon. Although not shown in FIG. 2, the second face 32 of the gate 26 is configured with matching seal trenches 38′, 40′. In essence, the first face 30 of the gate 26 is a mirror image of the second face 32.

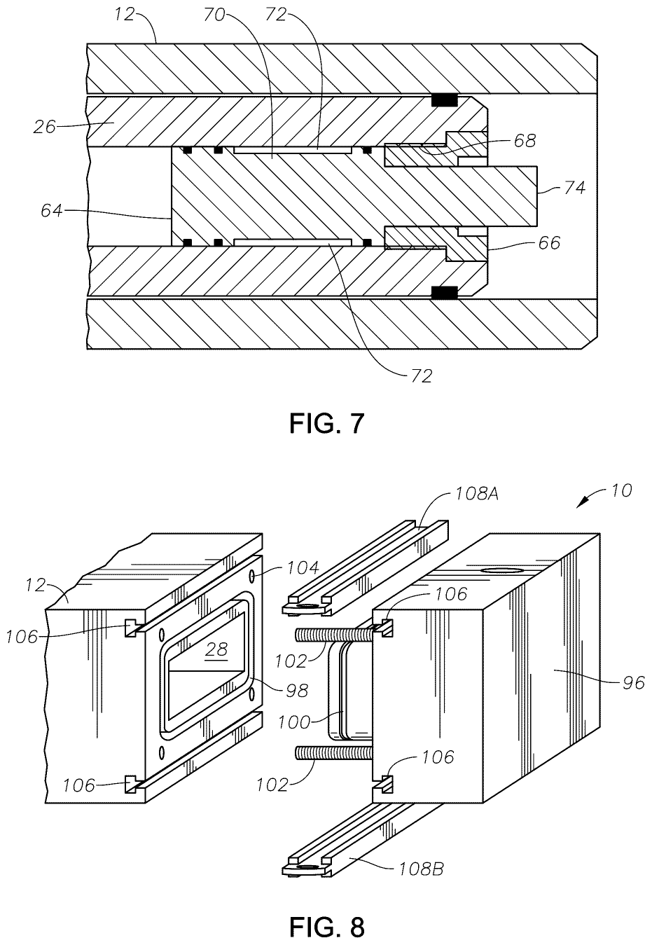

The gate 26 may be formed of any suitable material depending on the application (e.g., metal, composites, plastics, synthetic materials, etc.). As shown in FIG. 2, the gate 26 is disposed in the slot 28, which forms a passage transverse to the through bore 22 along the longitudinal axis of the valve 10 body 12 (see FIGS. 4, 5, 6). The gate 26 is formed to fit within the slot 28 at a close tolerance yet allowing the gate to move or slide within the slot as described below. As depicted in FIG. 2, the gate 26 is configured for easy insertion and extraction from the slot 28, akin to a cartridge in a player. This provides a notable advantage compared to conventional valve designs, which typically require removal of the entire valve for repair or refurbishment. Some embodiments may be implemented with a seal or band 42 (e.g., a rubber band) disposed in a groove 44A formed on the gate 26 surface near the center to provide a wiper for the internal surface of the slot 28 as the gate moves back and forth therein. Embodiments may also be implemented with additional wiper bands or seals disposed in other grooves 44B on the gate 26. FIG. 2 also shows the gate 26 configured with a threaded port 46A at one end (further described with respect to FIG. 7).

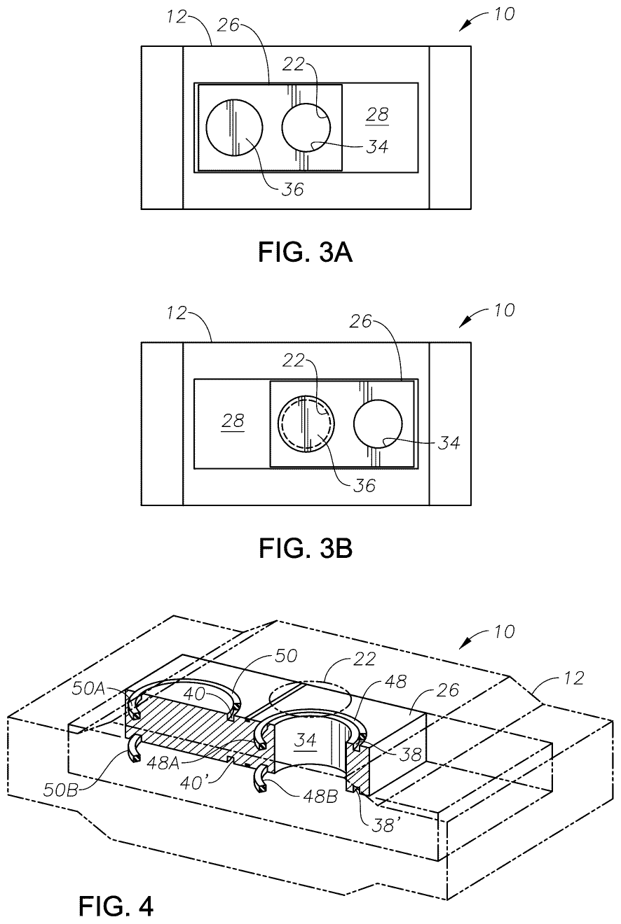

FIG. 3A shows an overhead cutaway schematic of a valve 10 embodiment of this disclosure. The gate 26 is shown in the open position, with the opening 34 coincident and aligned with the through bore 22. In this open position, any fluid traversing the through bore 22 from either the first face 30 or the second face 32 is free to flow through the gate 26 opening 34 and in-out through the valve 10.

FIG. 3B shows the valve 10 of FIG. 3A with the gate 26 in the closed position. When the gate 26 is moved (as described below) to the other end of the slot 28 compared to FIG. 3A, the solid surface area 36 of the gate 26 fully covers the through bore 22, preventing fluid passage therethrough.

Turning to FIG. 4, a transparency view of a valve 10 embodiment according to this disclosure is shown. The gate 26 is shown in the open position, as described with respect to the embodiment of FIG. 3A. In this embodiment, the gate 26 is configured with a first seal assembly 48 disposed at the gate opening 34 and a second seal assembly 50 disposed at the solid surface area 36 (see FIG. 2). First seal assembly 48 includes a first seal 48A disposed in the seal trench 38 formed on the first face 30 of the gate 26, and a second seal 48B disposed in a mirroring seal trench 38′ formed on the second face 32 of the gate (see description of FIG. 2). The second seal assembly 50 likewise includes a first seal 50A disposed in the seal trench 40 formed on the first face 30 of the gate 26, and a second seal 50B disposed in a mirroring seal trench 40′ formed on the second face 32 of the gate (see description of FIG. 2).

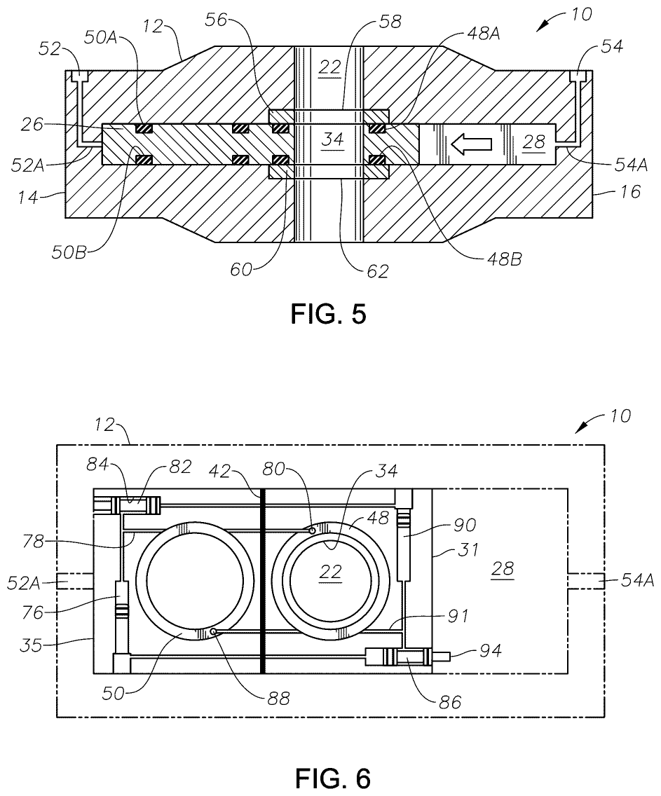

FIG. 5 shows a cross section of a gate 10 embodiment according to this disclosure. As depicted in FIG. 5, the first and second seal assemblies 48, 50 may be implemented with conventional radial seals 48A, 48B, 50A, 50B (see FIG. 4) to restrict fluid passage between the through bore 22 and the slot 28. Some embodiments may also be implemented with the seals 48A, 48B, 50A, 50B configured for energization to urge the respective seal faces against the surfaces to be sealed. Such seals are further described in Intl. Pat. Apps. WO20211142004 and WO20211141999, both assigned to the present assignee and incorporated herein by reference.

FIG. 5 also shows a first fluid port 52 leading to an internal fluid passage 52A that traverses the valve 10 body 12 to provide a fluid feed to the slot 28 at the first end 14. A second fluid port 54 is disposed at the second end 16 of the valve 10 and leads to another internal fluid passage 54A that traverses the valve body 12 to provide a fluid feed to the slot 28 at the second end. As shown in FIG. 5, the valve 10 is in the open position with the gate 26 abutting the slot 28 wall at the first end 14 of the valve. As described herein, in this position the gate 26 opening 34 is coincident with the through bore 22, permitting fluid flow therethrough from either end across the valve 10 body 12. The gate 26 is set in the open position by maintaining a constant fluid pressure in the slot 28 at the second end 16 via fluid passage 54A, as depicted by the arrow in FIG. 5.

To close the valve 10, fluid is introduced under pressure through the first fluid port 52, via fluid passage 52A and into the slot 28 at the first valve 10 end 14. Simultaneously, fluid pressure is released from the slot 28 at the second end 16 via second fluid port 54. As fluid pressure at the first end 14 overcomes the pressure at the second end 16 of the slot 28, the gate 26 is pushed from the open to the closed position (left to right in the page). FIG. 3B shows a valve 10 with the gate 26 in the closed position. Although the first and second fluid ports 50, 52 are shown disposed at the first planar surface 18 of the valve 10, it will be appreciated that other embodiments may be implemented with the ports located at other surfaces (e.g., first end 14, second end 16, second planar surface 20, etc.) to facilitate mounting of the valve depending on the application.

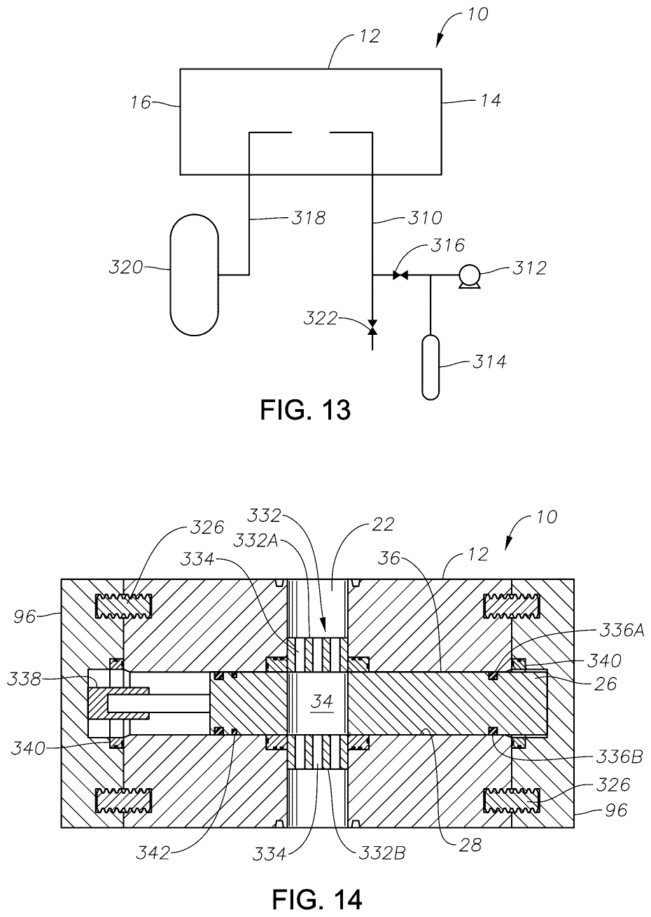

Fluid pressure to move the gate 26 from the open-to-closed position, and vice-versa, as described herein, may be provided by a separate pump and fluid (e.g., hydraulic fluid) reservoir system coupled to the first and second fluid ports 52, 54 (sec FIGS. 9 and 13). As such, the valve 10 embodiments provide a closed system for the fluid to move the gate 26. FIG. 5 also shows a valve 10 embodiment configured with a first annular seat 56 disposed in a channel 58 formed in the body 12 above the gate 26 coincident with the through bore 22. A second annular seat 60 is disposed in another channel 62 formed in the body 12 below the gate 26 coincident with the through bore 22. The first and second annular seats 56, 60 may be formed of more durable materials (e.g., stainless steel, INCONEL™, ceramics, tungsten carbide, etc.) compared to the valve 10 body 12. Since scaling at the through bore 22/gate 26 junction is important to an efficient and effective valve 10, the annular seats 56, 60 provide a hardwearing corrosive-resistant surface to sustain a good seal via the seal assemblies 48, 50, particularly when implemented with energizable seals. In applications with fluids containing damaging or abrasive elements (e.g., sand contamination), the combination of seals 48, 50 and seats 56, 60 provides the necessary scaling to prevent migration of undesired contaminants internally within the valve 10. Placement of the seal assemblies 48, 50 on the gate 26 cartridge provides a significant advantage compared to conventional valves. Valves 10 configured with hardwearing annular seats 56, 60 can provide the required sealing ability for extended operation since the seal assemblies 48, 50 can be easily replaced in the field (without having to remove the valve 10 from the system) by extraction and refurbishment or replacement of the gate 26 cartridge as described herein.

Turning to FIG. 6, a transparency cutaway view of the top of a valve 10 embodiment according to this disclosure is shown. Valve 10 embodiments implemented with energizable radial seal assemblies 48, 50 entail the use of a pressurized fluid, gas, compounds, springs, or combinations of the aforementioned to energize the seals to provide a superior seal at the through bore 22/gate 26 junction. Usable seal embodiments include those described in Intl. Pat. Apps. WO20211142004 and WO20211141999. FIG. 6 shows a gate 26 embodiment configured with internal fluid passages to channel fluid to energize the seals disposed on the gate.

The valve 10 of FIG. 6 is shown in the open position, with the gate opening 34 coincident with the through bore 22. In this mode, the seals 48A, 48B of the first seal assembly 48 are energized up by fluid pressure provided by a reservoir of fluid (e.g., hydraulic fluid) fully contained within the gate 26. When the valve 10 is in the closed position, the second seal assembly 50 (on the left side of the page) is energized up. During the transition phase between open-close-open, the respectively engaged seals begin to de-energize, allowing the gate 26 to move while the other seals become energized.

The gate 26 is configured with two fluid timing circuits. Each circuit activates one of the seal assemblies 48, 50. Each circuit is implemented by a valve spool and a fluid reservoir interconnected via internal fluid passages disposed on the gate 26. FIG. 7 shows a cross section of a valve spool 64 embodiment according to this disclosure. The spool 64 is configured with a plug 66 that is threaded into an internal passage 68 within the gate 26 (e.g., via port 46A of FIG. 2). An internal plunger 70 provides an annular flow space 72 between sealed ends (e.g., via O-rings). When acted upon by fluid pressure or physical contact with the gate 26 body, the plunger 70 is free to move within the internal passage 68 in the gate. In one position, a distal end 74 of the plunger extends outward past the end of the gate 26 (see plunger 94 of FIG. 6).

Returning to FIG. 6, the valve 10 is in the open position, allowing unrestricted fluid passage through the gate 26 via the opening 34/through bore 22. In this open position, a first fluid reservoir 76 in the gate 26 provides hydraulic fluid under pressure (via a spring-piston unit) through a first internal fluid passage 78 that provides an outlet 80 at the seal trenches 38, 38′ (see FIG. 2) underneath each seal 48A, 48B to energize up each seal. In this position, the second end 35 of the gate 26 is pushed up against the valve body 12 wall by the fluid pressure applied to the first end 31 of the gate via internal fluid passage 54A. The distal end of a first valve spool 82 plunger is pressed into the receiving port 84 as the gate 26 abuts the body 12 wall. With the plunger in this position, the annular flow space provided by the plunger links the internal fluid passages as shown to allow fluid under pressure from the first fluid reservoir 76 to flow through the outlet 80 to energize up the seals 48A, 48B against the surfaces of the respective first and second annular seats 56, 60 (see FIG. 5).

The plunger on a second valve spool 86 is positioned to block fluid flow via the respective internal fluid passages leading to another outlet 88 at the seal trenches 40, 40′ of the other seals 50A, 50B (see FIG. 5) to keep those seals de-energized. When activating the gate 26 from the open position (as shown in FIG. 6) to the closed position by activation fluid pressure via internal fluid passage 52A, a second fluid reservoir 90 in the gate 26 commences drawing in the fluid through the internal passages 91 (via a spring-piston unit) to allow the fluid under the seals 48A, 48B to discharge into the reservoir, allowing the seals to de-energize and release sealing pressure against the annular seat 56, 60 surfaces. Simultaneously, as the gate 26 transitions to the closed position (left to right in the page), the other seals 50A, 50B begin to energize up via fluid pressure through the internal passages as the gate 26 moves to the closed position. When the gate 26 is in the fully closed position, with the first end 31 of the gate abutting against the valve body 12 wall (right side of FIG. 6), the extended distal end 94 of the second valve spool 86 will be pressed into the receiving port to allow maximum fluid flow under pressure from the second fluid reservoir 90 to flow through the outlet 88 to energize up the seals 50A, 50B against the surfaces of the annular seat 56, 60, while the other seals 48A, 48B are de-energized.

The disclosed fluid timing circuits channel the internal gate 26 fluids in this manner as the valve 10 cycles through open-closed sequences. The closed fluid system providing the fluid pressure to move the gate 26 back and forth via ports 52, 54 and the self-contained gate 26 fluid timing circuits in essence comprise a hydraulics-over-hydraulics closed system, which aids in keeping the fluids free of contaminants.

By maintaining a good seal while the valve 10 is set in the open or closed position and while the gate 26 is moving, maximum protection is provided against contaminant migration as the valve transitions. For example, when flowing fluids with high sand concentrations, the timed energization of the seal assemblies 48, 50 keeps the sand in the through bore 22 from migrating into the valve body 12. By preventing such ingress of debris into the valve 10 body the effective operational life of the valve is extended.

FIG. 8 shows a blowup of a valve 10 with a detachable end cap 96 embodiment according to this disclosure. As used herein for purposes of this disclosure, the words “detachment”, “detached”, and “detachable” are meant to encompass a component fully separated from other components as well as a component partially separated from other components (e.g., a hinged lid, hinged door, etc.). The valve 10 body 12 embodiment of FIG. 8 shows the body end configured with a seal groove 98 to receive a radial seal 100 (e.g., O-Ring) to maintain a sealed passage 28 for the gate 26. One or more guide pins 102 may also be inserted in holes 104 formed in the end cap 96 and the valve 10 body 12 to provide increased structural stability. Valve 10 embodiments may be implemented with one detachable end cap 96 disposed solely at one end thereof or with a pair of end caps, each mounted at an opposing end of the valve body. Embodiments implemented with a pair of end caps 96 facilitate the removal and insertion of the gate 26 from either end of the valve 10 body 12.

As shown in FIG. 8, an embodiment may be implemented with H-channels 106 formed transversely to the longitudinal axis of the body 12 on each end of the body and the end cap 96. When the end cap 96 is fitted against the valve 10 body, a pair of elongated I-bars 108A, 108B are used to maintain the cap in place. Each I-bar 108A, 108B is inserted from one side of the body 12 to slide into place for complementary engagement within the H-channels 106 formed on the cap 96 and body 12. The I-bars 108A, 108B may be secured in place by a conventional fastener. When it is desired to replace the gate 26 cartridge (e.g., to replace all the working seals), the I-bars 108A, 108B are pulled out of the H-channels 106 to free the end cap 96 for detachment to allow access to the gate via the passage 28. Once the end cap 96 is detached, the gate 26 cartridge can be removed and replaced while keeping the valve 10 in place. It will be appreciated by those skilled in the art that other detachable end cap 96 configurations may be implemented with the valves 10 using conventional hardware means and components.

FIG. 9 shows a valve 10 embodiment of this disclosure implemented in a fluid flow system 200 (e.g., an oilfield fracking operation). The fluid supply to move the gate 26 in the valve 10, as disclosed herein, may be provided via supply lines 202, 204 in the system 200. Other embodiments may be implemented with the valve 10 configured with its own independent fluid reservoir and pump unit to provide the required fluid pressure to the gate 26. Valve 10 embodiments may also be implemented with a conventional controller 206 and software as known in the art to activate the fluid flow to operate the gate 26. Some embodiments may also be implemented with a conventional antenna for wireless remote valve 10 activation via the controller 206.

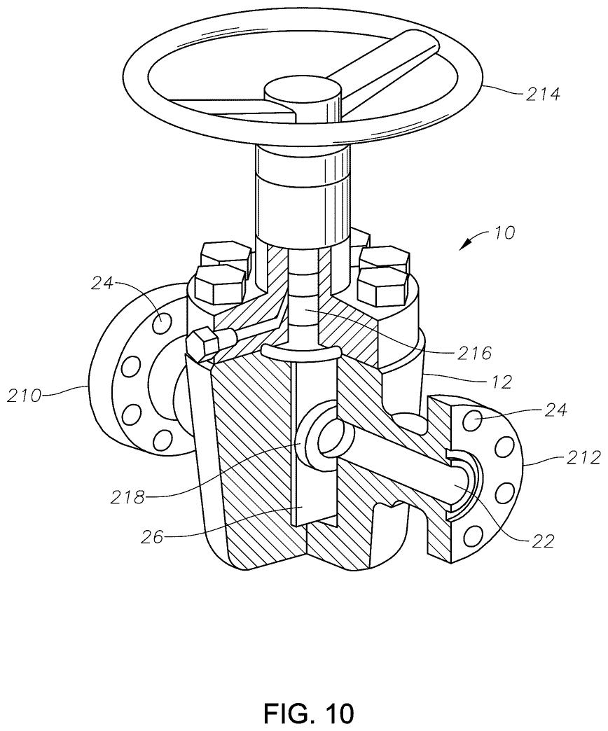

FIG. 10 shows another valve 10 embodiment according to this disclosure. It will be appreciated by those skilled in the art that the closed-fluid seal energization systems provided by the gate 26 embodiments disclosed herein are not limited to any particular operation or implementation. FIG. 10 shows an embodiment implemented with a conventional stemmed gate valve 10 design. The valve 10 is configured for manual operation to open-close the gate 26 to allow fluid passage via the through bore 22 across a first end 210 and a second end 212. A handle 214 is coupled to a stem 216, which is linked through the valve 10 body 12 to the gate 26. Rotation of the handle 214 causes the gate 26 to move between an open and closed position, selectively controlling fluid flow across the through bore 22. The gate 26 may be configured with the energizable seals 218 and features as disclosed herein.

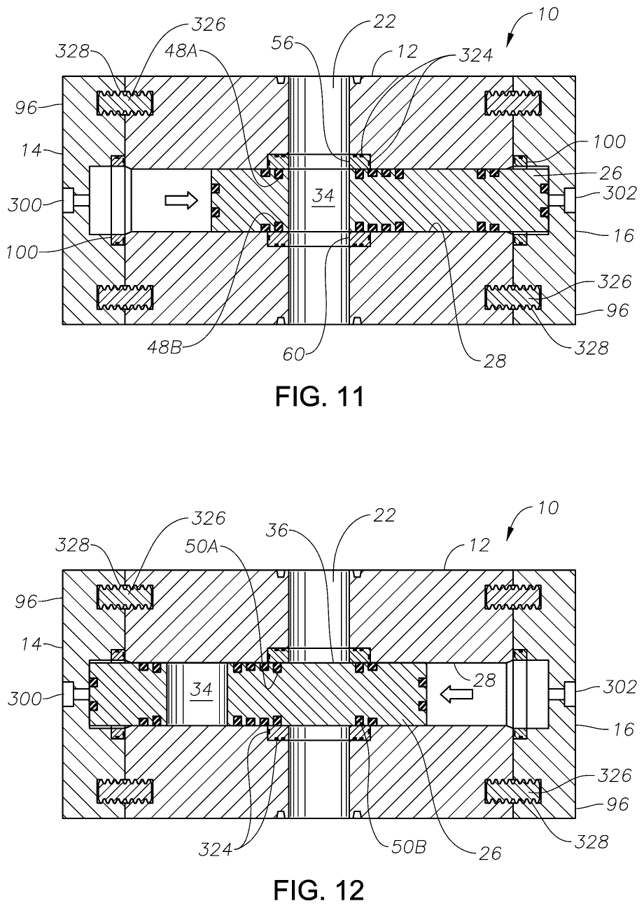

FIG. 11 shows a cross section of another valve 10 embodiment according to this disclosure. This embodiment is like the other embodiments disclosed herein. However, one difference is the application of different gate 26 activation forces. A first fluid port 300 leads to an internal fluid passage to provide a fluid feed to the slot 28 at the first end 14 of the body 12. When fluid (e.g., hydraulic fluid) is introduced under pressure via the port 300, the fluid pressure provides the motive force against the end of the gate 26 (depicted by the arrow in FIG. 11) to push the gate within the transverse passage 28. As shown in FIG. 11, the valve 10 is in the open position with the gate 26 abutting the slot 28 wall at the second end 16. As described herein, in this position the gate 26 opening 34 is coincident with the through bore 22, permitting fluid flow therethrough from either side across the valve 10 body 12. The gate 26 is set in the open position by maintaining a constant fluid pressure in the slot 28 at the first end 14 via fluid port 300. A second fluid port 302 is disposed at the second end 16 of the valve 10 and leads to another internal fluid passage to provide a fluid feed to the slot 28 at the second end. In some embodiments, the second port 302 is linked to a gas source to provide a pressurized gas motive force against the end of the gate 26 (depicted by the arrow in FIG. 12) to push the gate toward the first end 14 within the transverse passage 28.

FIG. 13 shows a schematic of the fluid system for the valve 10 embodiments depicted in FIGS. 11 and 12. When the valve 10 is in the open position (FIG. 11), the fluid feed 310 provides the motive force acting against the end of the gate 26 as described above. Fluid feed 310 is coupled to the first fluid port 300 (FIG. 11). The fluid may be provided via a conventional fluid pump 312 and/or a conventional accumulator 314. The pump 312 may be used to keep the accumulator 314 charged with fluid to a desired pressure. It will be appreciated by those skilled in the art that other pressurized fluid sources may be used to implement embodiments of this disclosure (e.g., remote fluid reservoirs/pumps, ROVs, etc.). A control valve 316 may be linked into the system to actuate fluid flow into the valve 10 via port 300 (see FIG. 11) to act on the gate, transitioning the valve to the open position as shown in FIG. 11. On the other side 16 of the valve 10, a pressurized gas feed 318 provides the motive force acting against the opposite end of the gate 26. Gas feed 318 is coupled to the second fluid port 302 (FIG. 11). A gas accumulator or gas bottle 320 may be linked to the feed 318 to provide the gas supply. Any suitable gas may be used depending on the application (e.g., conventional nonreactive gases). It will be appreciated by those skilled in the art that other pressurized gas sources may be used to implement embodiments of this disclosure (e.g., coupled remote gas reservoirs, ROVs, etc.). The fluid system also incorporates a vent valve 322 linked into the line on the first side 14 of the valve 10. Vented fluid may be diverted to a holding tank/reservoir coupled to the system.

Returning to FIG. 11, operation of the fluid system is described. When it is desired to actuate the valve 10 to the open position, fluid is introduced under pressure via port 300. The fluid is introduced with sufficient pressure to act against the end of the gate 26 (arrow in FIG. 11), overcoming the force of the gas acting on the opposite side of the gate. The gas on the opposite side of the gate is compressed and migrates to the accumulator or gas bottle 320. The valve 10 will remain in the open position provided the fluid feed 310 (see FIG. 13) maintains sufficient pressure against the gate 26 to overcome the gas feed 318 pressure on the opposite side of the gate.

FIG. 12 shows the valve 10 in the closed position. When it is desired to close the valve 10, the control valve 316 (see FIG. 13) is closed to stop fluid ingress via port 300 and vent valve 322 is opened. Once the vent valve 322 is opened, the fluid pressure on the gate 26 end drops very quickly. As the fluid pressure drops on the first end 14 of the gate 26, the compressed gas expands in the closed chamber supplied by the accumulator or gas bottle 320. As the gas expands, the pressure acts of the end of the gate 26 (arrow in FIG. 12) to shift the gate into the closed position. It will be appreciated that embodiments as disclosed in FIGS. 11 and 12 provide a fail-safe valve 10 whereupon the gate 26 automatically reverts to the closed position (via expanding pressurized gas feed 318) when fluid pressure drops or ceases via fluid feed 310. Embodiments may be implemented wherein the control valve 316 and/or the vent valve 322 (FIG. 13) may be actuated manually, remotely, and/or automatically and autonomously.

As with other embodiments of this disclosure, the embodiments of FIGS. 11 and 12 may be implemented with first and second annular seats 56, 60 disposed in the main body 12 as previously described. In Some embodiments, the annular seats 56, 60 may be configured with one or more radial/face seals 324 to provide greater sealing integrity. The valves 10 may also be configured with first and second seal assemblies 48, 50, which can be implemented with conventional radial seals 48A, 48B, 50A, 50B (see FIG. 4) to restrict fluid passage between the through bore 22 and the slot 28. Some embodiments may also be implemented with the seals 48A, 48B, 50A, 50B configured for energization to urge the respective seal faces against the surfaces to be sealed. Such seals are further described in Intl. Pat. Apps. WO20211142004 and WO20211141999. In some embodiments, the valves 10 may be configured for seal 48A, 48B, 50A, 50B energization via the expanding gas from gas feed 318 as described above.

As shown in FIGS. 11 and 12, some valve 10 embodiments may be implemented with elongated saw-tooth bars 326 that slide into complementary channels 328 formed transversely to the longitudinal axis of the body 12 on each end of the body and the end caps 96. When the end cap 96 is fitted against the valve 10 body, a pair of elongated saw-tooth bars 326 are used to maintain the cap in place. The saw-tooth bars 326 may be secured in place by a conventional fastener. When it is desired to replace the gate 26 cartridge (e.g., to replace all the working seals), the saw-tooth bars 326 are pulled out of the channels 328 to free the end cap 96 for detachment to allow access to the gate via the passage 28. Once an end cap 96 is detached, the gate 26 cartridge and/or the annular seats 56, 60 can be removed and replaced while keeping the valve 10 mounted in place.

FIG. 14 shows a cross section of another valve 10 embodiment according to this disclosure. This embodiment incorporates an annular insert 332 disposed within the main body 12, with a sleeve portion fitted coincident with the through bore 22. The insert 332 is configured in two sections 332A, 332B, with the sections fitted within the through bore 22 across from one another. Each insert section 332A, 332B includes one or more voids or openings 334 passing through the insert body to permit fluid passage through the insert body, and therefore across the through bore 22. As shown in the embodiment of FIG. 14, the openings(s) 334 may be configured as cylindrical passages traversing through the insert 332 body. The insert 332 embodiment of FIG. 14 includes a plurality of openings 334 aligned in parallel with the longitudinal axis of the through bore 22. Other insert 332 embodiments may be implemented with the openings 334 formed in different geometric configurations (e.g., oval, crescent, triangle, etc.) or with combinations of geometric shapes, all with the same dimensions or in varying dimensions. Some embodiments may be formed with the opening(s) 334 oriented or slanted with respect to the longitudinal axis of the through bore 22 (e.g., angled, spiral, or S-shaped channel). The openings 334 in the inserts 332 provide restriction channels that help diffuse and control fluid flow via the valve 10 through bore 22, particularly in high-pressure fluid flow applications. The inserts 332 may be formed of any suitable material depending on the application (e.g., metal, composites, plastics, synthetic materials, etc.). The insert sections 332A, 332B may be easily removed and swapped to provide different diffusion effects by freeing an end cap 96 and removing the gate 26 as described herein.

As shown in FIG. 14, some valve 10 embodiments may be configured with the gate 26 having one seal assembly 336A, 336B to provide sealing for both the gate opening 34 and the solid surface area 36 when the gate is in the closed position. FIG. 14 shows the valve 10 in the open position. The seal assembly 336A, 336B may be implemented with conventional radial seals to restrict fluid passage between the through bore 22 and the slot 28, or with seals configured for energization to urge the respective seal faces against the surfaces to be sealed (e.g., as described in Intl. Pat. Apps. WO20211142004 and WO20211141999). Valve 10 embodiments of this disclosure may also be implemented with conventional or energizable radial/face seal carriers 340 disposed between the end caps 96 and main body 12 junctions.

The valve 10 embodiment of FIG. 14 is also implemented with an actuator 338 linked to the gate 26 to provide the motive force to move the gate along the transverse passage 28 between the open and closed positions. The actuator 338 is linked to one end of the gate 26. Conventional actuators 338 may be used to implement valve 10 embodiments in accordance with this disclosure (e.g., EXLAR™ linear rotor screw actuators, hydraulic actuators, servos, etc.). Containment of the actuator 338 inside the valve 10 body 12 avoids the need for shaft seals, which prevents fugitive emissions (e.g., sand slurry and other substances entering the cavity between the gate and the body during service). Such embodiments provide a low-activation force and balanced gate valve 10. When the valve 10 is to be opened, the actuator 338 is activated to apply a compressive or pushing force against the gate 26 (to the right in FIG. 14). When the valve 10 is to be closed, the actuator 338 is activated to apply a tension or pulling force on the gate 26 (to the left in FIG. 14). Power and/or fluid pressure for the actuator 338 may be provided via any suitable means as known in the art. Some embodiments may also be implemented with a wiper seal 342 disposed on the gate 26 near the end closest to the actuator 338.

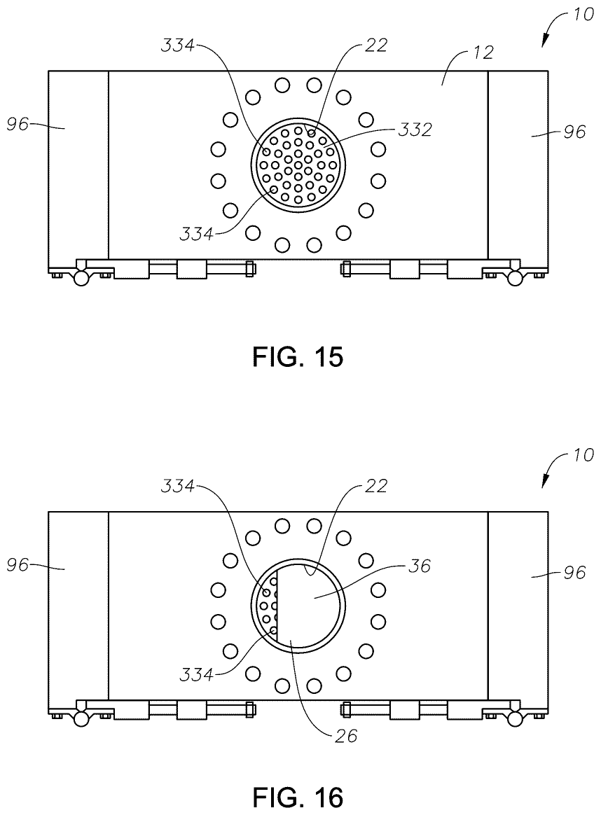

FIG. 15 shows an overhead view of the valve 10 of FIG. 14 with the gate 26 in the fully open position. In this mode, fluid flow via the through bore 22 is diffused by the plurality of openings 334 in the insert 332. FIG. 16 shows an overhead view of the valve of FIG. 14 with the gate 26 in a near closed position. In this mode, fluid flow via the through bore 22 is restricted by the gate 26 and diffused by the uncovered openings 334 in the insert 332. The actuator 338 may be activated to move the gate 26 within the passage 28 to any desired position between fully closed and fully open.

An advantage of the disclosed valve 10 embodiments includes the implementation of a valve 10 that can be repaired/refurbished in the field, without needing to remove the valve unit from the operational system. Another advantage is the implementation of a valve 10 with the working components (e.g., seals) disposed in the gate 26, making it very easy and efficient to replace key components via a swappable gate cartridge. The disclosed valves 10 do not require any packing or grease filling as used with conventional stemmed valve designs. By providing seals on both surfaces of the gate 26, the valves 10 provide balanced upstream flow and downstream flow sealing between the gate and the body 12. The disclosed valves 10 prevent fugitive emissions when the valve is in the open or closed position and while the gate 26 is in transition.

It will be appreciated that embodiments of the disclosed valves 10 may be implemented for use in numerous applications and operations, in the oil and gas industry and in other fields of endeavor. For example, the disclosed valve 10 embodiments may be deployed for use at surface, above surface, subsurface, and under water. It will be appreciated by those skilled in the art that embodiments of this disclosure may be implemented with conventional hardware components (e.g., conventional fasteners, seals, valve spools, etc.) and parts formed of suitable materials depending on the application. It will also be appreciated that embodiments may be implemented with control units locally or remotely linked to the valves 10 as known in the art. The control unit(s) may comprise any suitable microcomputer, processor, controllers, memory, and associated electronics, and may be programmed to activate and operate the valves 10 as described herein. In some embodiments, the control unit can be programmed to perform autonomous and automatic actuation of the valves and components as described herein. Power for the apparatus and valve 10 systems may also be implemented, for example, using conventional batteries as known in the art. Although only a few examples have been described in detail above, those skilled in the art will readily appreciate that many modifications are possible in the examples. Accordingly, all such modifications are intended to be included within the scope of this disclosure.

What is claimed is:

1. A valve comprising:
a main body having a through bore;
a passage transverse to the through bore;
a gate disposed in the transverse passage,
wherein the gate is configured for motion between a position with an opening on the gate coincident with the through bore to permit fluid flow via the through bore and a position to restrict fluid flow via the through bore; and
wherein the gate is configured for motion along the transverse passage in one direction in response to a first force acting on the gate and in another direction in response to a second force acting on the gate.

2. The valve of claim 1 further comprising an insert disposed in the main body coincident with the through bore; the insert configured with a plurality of openings formed thereon, wherein the gate is configured for movement along the transverse passage to control fluid flow via the plurality of openings.

3. The valve of claim 1 further comprising an actuator configured to apply a force on the gate to move the gate along the transverse passage.

4. The valve of claim 3 wherein the actuator is disposed inside the main body.

5. The valve of claim 1 wherein the gate comprises at least one seal to restrict fluid flow between the through bore and the transverse passage.

6. The valve of claim 1 wherein the gate comprises at least one seal configured for energization to restrict fluid flow between the through bore and the transverse passage.

7. The valve of claim 6 wherein the gate is configured with an internal fluid passage to channel fluid to energize the at least one seal configured for energization.

8. The valve of claim 1 wherein the body is configured with a first internal passage to channel fluid to apply the first force on the gate to move the gate along the transverse passage.

9. The valve of claim 8 wherein the body is configured with a second internal passage to channel fluid to apply the second force on the gate in opposition to the first force to move the gate along the transverse passage.

10. The valve of claim 9 wherein the gate is configured for motion toward the position to restrict fluid flow via the through bore when one of the first force or the second force applied on the gate is reduced.

11. The valve of claim 8 wherein the body is configured with a second internal passage to channel a gas to apply the second force on the gate in opposition to the first force to move the gate along the transverse passage.

12. The valve of claim 11 wherein the gate is configured for motion toward the position to restrict fluid flow via the through bore when the second force is greater than the first force applied on the gate.

13. The valve of claim 1 wherein the gate has a first surface and a second surface opposite the first surface, with a first seal disposed on the first surface and a second seal disposed on the second surface.

14. The valve of claim 13 wherein the first seal and the second seal are each configured to restrict fluid flow between the through bore and the transverse passage when the gate is in the position to restrict fluid flow via the through bore.

15. The valve of claim 13 wherein the first seal and the second seal are each configured to restrict fluid flow between the through bore and the transverse passage when the gate is in the position to permit fluid flow via the through bore.

16. The valve of claim 1 wherein the gate is configured for motion free of any mechanical linkage.

17. The valve of claim 1 further comprising a cap mounted on the main body and configured for detachment to respectively permit removal and insertion of the gate from/into the body.

18. A method of operating a valve having a main body with a through bore, comprising:
applying a force on a gate to move the gate along a passage in the main body transverse to the through bore,
wherein the gate is configured for motion along the transverse passage between a position with an opening on the gate coincident with the through bore to permit fluid flow via the through bore and a position to restrict fluid flow via the through bore; and
wherein the gate is configured for motion along the transverse passage in one direction in response to a first force acting on the gate and in another direction in response to a second force acting on the gate.
